(19) United States
(12) Patent Application Publication
(10) Pub. No.: US 2014/0129618 A1
(43) Pub. Date: May 8, 2014

(54) METHOD OF STREAMING MULTIMEDIA DATA OVER A NETWORK

(71) Applicant: GENERAL INSTRUMENT CORPORATION, Horsham, PA (US)

(72) Inventors: Krishna Prasad Panje, Bangalore (IN); Sundar Murthy Tumuluru, Bangalore (IN)

(73) Assignee: GENERAL INSTRUMENT CORPORATION, Horsham, PA (US)

(21) Appl. No.: 13/672,691

(22) Filed: Nov. 8, 2012

(51) Int. Cl. G06F 15/16

(52) U.S. Cl. 709/203

(57) ABSTRACT

A method of streaming multimedia data over a network to a client device is provided. At least one playlist file is downloaded using a transfer protocol, such as HLS, from a streaming server over the network for a selected multimedia presentation. The client device subscribes to an update event notification service with the streaming server or an intermediate server with respect to the at least one playlist file for the selected multimedia presentation and then listens for an update event notification. Only when such a notification is transmitted by the streaming server or the intermediate server to the client device is an updated version of the at least one playlist file downloaded by the client device from the streaming server over the network using the transfer protocol.

### BACKGROUND

Streaming is a technique for delivering multimedia data corresponding to a multimedia presentation or content to end-users and typically involves continuously displaying media content to a user while the multimedia data is being delivered to the user. One particular form of streaming is known as Hypertext Transfer Protocol (HTTP) Live Streaming (HLS) and provides a technique for streaming content using HTTP to broadcast so-called “live” content. As merely one example, the streamed content can correspond to video and/or audio currently being broadcast on a television TV channel (i.e., live TV) by a service provider. Thus, an end user may watch live streaming TV channels on television monitors connected to IP client set-top boxes as well as other IP client devices such as tablets, smartphones, laptop computers and the like.

In HLS, incoming media data from a source is segmented into multiple media files which are stored on a server, and a playlist file is created that includes Uniform Resource Identifiers (URIs) that direct a client device to the segmented media files stored on the server. When the segmented media files are played in accordance with the playlist file, the client device can provide the user with a broadcast of a real-time, near real-time, or “live” event or broadcast. Of course, pre-recorded content can be provided in a similar manner. For purposes of this disclosure, “real-time” includes a level of responsiveness that is sufficiently fast, for instance, to keep up with a series of images captured by the system as well as a level of responsiveness that tolerates a degree of lateness. As an alternative, the data does not need to be streamed in real-time and can be provided or made available with expected delays.

Typically, the multimedia data is processed and made available for transfer soon after it has been created. Thus, changes to the data and playlist files including variant playlist files for the data may require frequent updating. Also, additional, supplementary or alternative media content (e.g., advertisements, additional media content to the main presentation, etc.) may be dynamically introduced into the broadcast event. Accordingly, the server may continue to add additional URIs to the playlist files during client playback of a media event or presentation. The URIs identify a location from which a client device can download a supplementary, updated or newly created media files. Thus, the client device is required to frequently and periodically retrieve from the server playlist files for purposes of determining whether or not updates or changes have been made and to access any updated, supplementary, and additional media content the server has introduced.

Service providers, such as providers of terrestrial, cable and satellite digital TV may offer HTTP live streaming via their networks and, for instance, may provide set-top boxes and like customer premise equipment, gateways, servers, etc. which can function as a HLS client device. The streaming server at the headend of such a network will typically create multiple variant bit rate streams for the same content thereby enabling HLS client devices at the customer premises to switch playlist files based on available network bandwidth for delivery of the media files from the server to the client device.

Accordingly, for each content or program, the server maintains different playlists with different bit rates (quality) indicating different files. A HLS client device may download these playlist files and can then determine available network bandwidth and select media files for download from an appropriate playlist. The HLS client device plays the media files one by one (i.e., content for a single program is split into several file chunks which are specified within a playlist). The HLS client device is required to periodically monitor bandwidth and download additional media files and updates of playlist files and media files and play the media files accordingly.

As discussed, different playlist files depending upon bitrate (quality) are stored on the server and the HLS client, such as a set-top box, must fetch files according to the playlist. All the playlist files are stored as different playlist files (for instance, in m3u8 format) and are located with a different URI. HLS client devices, such as set-top devices and mobile IP client devices, must download different playlist files associated with different bit rates. As these playlist files and content are dynamically updated on the server, the HLS client device must connect and re-connect to the server periodically to obtain the playlist files and compare the newly obtained playlist files with those previously downloaded to determine if any changes, updates or modifications have been made to the playlist files and then to download media files accordingly.

Since each playlist file is located by different URIs, client devices such as set-top boxes must perform the several operations each time before switching to read different playlists (or access several URIs one by one). First the current session must be closed to relinquish resources, and then a new session must be opened to read and update playlist files and again acquire resources. Thereafter the playlist files must be read and compared and a determination must be made as to whether or not playlist files have been changed from the last reload. A determination is then made with respect to which file to play from the playlist. Depending upon implementation and client device capability, the above steps may pose excessive overheads as software and hardware resources may be limited (i.e., reacquisition may fail because of other tasks have taken needed resources of the client device). The above typically results in sluggishness in download and playback. Further, HLS clients having limited computing and network availability and needing to access several URIs repeatedly will typically experience browser and other resource issues.

### BRIEF DESCRIPTION OF THE DRAWINGS

Various features of the embodiments described in the following detailed description can be more fully appreciated when considered with reference to the accompanying figures, wherein the same numbers refer to the same elements.

FIG. 1 illustrates a simplified system overview of a network according to an embodiment.

FIG. 2 illustrates architecture of a streaming server according to an embodiment.

FIG. 3 illustrates a sample playlist file according to an embodiment.

FIG. 4 illustrates a sample variant playlist file according to an embodiment.

FIG. 5 illustrates the steps of a method for a playlist fetch technique in accordance with an embodiment.

### DETAILED DESCRIPTION

For simplicity and illustrative purposes, the principles of the embodiments are described by referring mainly to examples thereof In the following description, numerous specific details are set forth in order to provide a thorough understanding of the embodiments. It will be apparent however, to one of ordinary skill in the art, that the embodiments may be practiced without limitation to these specific details. In some instances, well known methods and structures have not been described in detail so as not to unnecessarily obscure the embodiments.

According to an embodiment, a method of streaming multimedia data over a network to a client device is provided. At least one playlist file is downloaded using a transfer protocol from a streaming server over the network for a selected multimedia presentation. The client device subscribes to an update event notification service with respect to the at least one playlist file for the selected multimedia presentation and may receive an update event notification with respect to the at least one playlist file for the selected multimedia presentation. After receiving the notification, an updated version of the at least one playlist file is downloaded from the streaming server over the network using the transfer protocol.

According to another aspect of the embodiment, a method of streaming multimedia data from a streaming server over a network to a population of client devices is provided in which at least one playlist file for a selected multimedia presentation is provided by a streaming server for being downloaded by the population of client devices with a transfer protocol over the network. A subscription request is received from at least one of the population of client devices to an update event notification service with respect to updates made to the at least one playlist file for the selected multimedia presentation, and an update event notification is transmitted to the at least one of the population of client devices from which a subscription request was received when an updated version of the at least one playlist file is available for being downloaded by the population of client devices with the transfer protocol over the network.

According to an alternate embodiment, a method of streaming multimedia data over a network to a population of client devices is provided in which at least one playlist file is downloaded by an intermediate server from a streaming server for a selected multimedia presentation over the network using a transfer protocol. The at least one playlist file is periodically reloaded from the streaming server for the selected multimedia presentation over the network using the transfer protocol and a determination is made as to whether or not a version of the at least one playlist file obtained during reloading has been updated relative to a previously loaded version. Further, a subscription request is received by the intermediate server from at least one of the population of client devices to an update event notification service with respect to updates made to the at least one playlist file for the selected multimedia presentation, and an update event notification is transmitted to the at least one of the population of client devices from which a subscription request was received when an updated version of the at least one playlist file is available for being downloaded by the population of client devices from the streaming server.

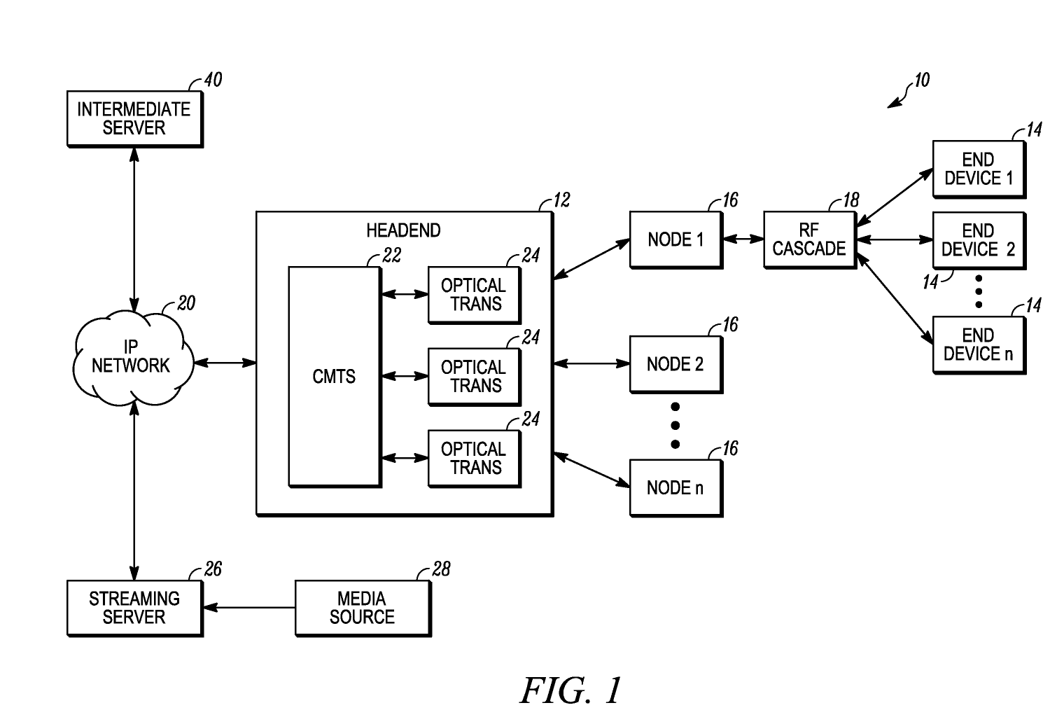

For purposes of example, a hybrid fiber-coax cable (HFC) network 10 is shown in FIG. 1 extending between a headend 12 and end devices 14 (also referred to herein as terminal devices and client devices) at subscriber locations. An example of an end device 14 is a set-top box located at a home or the like of a subscriber of a service provider of terrestrial, cable or satellite digital TV. It will be understood by a person having ordinary skill in the art that the conventional term “set-top box” should not be construed to limit the physical placement or configuration of such a device; for example, a set-top box is not limited to a device that is enclosed in a box, nor is it limited to a device positioned on top of a television set.

The end devices 14 may be Data Over Cable System Interface Specification (DOCSIS) devices, such as cable modems (CMs), modem terminal adapters, MTAs, set-top boxes, and embedded cable modems of DOCSIS set-top gateways (eCMs of DSGs), or any other like client device. The term DOCSIS refers to a group of specifications that define industry standards for cable headend and cable modem equipment. The end devices 14 are connected to the headend 12 of the network 10 via nodes 16 and an RF cascade 18 which may be comprised of multiple amplifiers and passive devices including cabling, taps, splitters, and in-line equalizers.

The headend 12 is interconnected to an IP (Internet Protocol) network 20. Data, such as audio, video and other data, may be provided from the IP network 20 to the end devices 14 via the headend 12. In addition, the end devices 14 may send data upstream on the network 10 to the headend 12. Although not shown in FIG. 1, each of the nodes 16 may be connected to multiple end devices.

As illustrated in FIG. 1, the headend 12 includes a cable modem termination system (CMTS) 22 and optical transceivers 24 which provide optical communications to and from the CMTS 22 through optical fiber to the nodes 16. A typical headend 12 will have a plurality of CMTS units with each CMTS containing a plurality of transceivers, which communicate with the plurality of end devices. For example, each CMTS 22 may have eight, forty-eight or more transceivers, and each transceiver may communicate with hundreds or more of end devices 14.

According to an embodiment, the end devices 14 are capable of functioning as an IP client device for purposes of handling HLS and performing HTTP fetches of playlist files and media files. Here, the end device 14 may be a set-top box that outputs the HLS content for display on a connected monitor or may relay the content to other HLS client devices, for instance, connected on a home or local area network. In some cases, the end device 14 may be a HLS client device having an integral display screen and speakers able to play the content as opposed to outputting it to another device for playing.

As shown in FIG. 1, the headend 12 may include a HLS or streaming server 26 that enables downloading and reloading of HLS playlists and media files which can be transferred via a transfer protocol, such as HTTP, to the end devices 14 via the network 10. For example, a MPEG transport stream may be RF modulated (i.e., QAM) onto a carrier (i.e., physical frequency) at the headend 12 for ultimate transmission via the network 10 to a population of set-top boxes connected to the network 10. In turn, each of the set-top boxes can use its physical in-band tuner or tuners to access a particular multiplex (i.e., QAM channel) from which it can then access the MPEG transport stream.

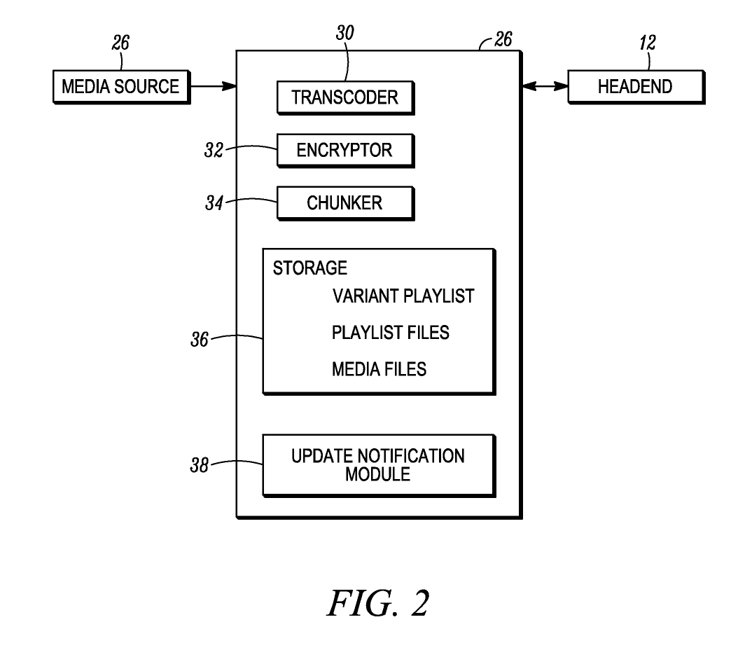

The streaming server 26 may obtain a stream of media data from an external source or the like and segment the media data into multiple media files that may be transferred, for instance, via HTTP. As best shown in FIG. 2, the streaming server 26 may obtain a multimedia presentation or the like in any form from an external media source 28. The multimedia presentation may first be subject to a transcoding process in the transcoder 30 whereby a single input stream is turned into a bouquet of streams, each encoded into a different resolution format and bit rate. The term “bouquet” as used herein refers to a collection of related streams, each constituting a unique bit rate and resolution pairing derived from the same original MPEG service. The multiplicity of different stream formats and bit rates enables the content to be sourced to devices with different capabilities. In addition, the different bit rates support adaptive streaming, whereby the receiving client has the ability to measure network congestion and request a lower or higher bit rate stream from the source which can help eliminate visual impairments caused by network congestion (e.g. macro-blocking due to dropped packets, frozen frames) at the expense of higher resolution video.

After transcoding, the bouquet of streams may be encrypted in an encryptor 32 or pre-encryptor and then chunked into segments in a chunker 34. The chunking process breaks each stream into time slices (e.g. 10 second period, 20 second period, or the like) and places the stream of packets for that period into a standard file format container that includes the packets and metadata describing the content. The files are placed in storage 36 on the server 26 which can then publish the files via the network 10 for distribution to the edges of the network (i.e., to end devices 14 and like customer devices or customer premise equipment). The end devices 14 may pull or fetch the files over the network 10 by the use of standard unicast HTTP gets or fetches. The adaptive end devices can continuously measure network performance and can adaptively request other file chunks containing higher or lower bit rate streams depending on the dynamic bandwidth that the network 10 can support.

Accordingly, the streaming server 26 segments the media data into chunks and stores the chunks in multiple media files that are in a form that may be transferred one-by-one or made available, for instance, via HTTP or other transfer protocol, to any of a population of end or client devices 14. In addition, the streaming server 26 also creates a playlist file or manifest corresponding to the segmented media files so that the stream of data can be readily reassembled by client devices after download. In response to one or more requests from an end or client device 14, the streaming server 26 may transmit one or more playlist files and media files.

The end device, or HLS client device, 14 may receive the playlist files and media files from server 26 over network 10. The end device 14 may be any type of electronic device that is capable of receiving data transmitted over a network and generate output utilizing the data received via the network, for example, a set-top box, a wireless mobile device, a server, a gateway, a computer, an IP client device, a tablet, a laptop computer, a smartphone, or the like. The output may be any media type or combination of media types, including, for example, audio and video.

The HLS client device 14 receives playlist files from the server 26 and uses the playlist files to access and download media files from the server 26 for a selected multimedia presentation. The HLS client device 14 includes memory (e.g. flash memory or DRAM, etc.) to act as a buffer to store the media files (e.g. compressed media files or decompressed media files) as they are received. The buffer can provide many seconds worth of presentable content beyond the time of content currently being presented so that the buffered content can later be displayed while new content is being downloaded. The buffer can provide presentable content while the client device is attempting to retrieve content through an intermittently slow network connection and hence, to some extent, can hide network latency or connection issues.

The playlist file can be an ordered list of URIs with each URI in the playlist file identifying a media file that is a segment of a stream, which may be a single contiguous stream of media data for a particular program, content or multimedia presentation. The playlist files may be, for example, Extended M3U Playlist files. M3U refers to Moving Picture Experts Group Audio Layer 3 Uniform Resource Locator (MP3 URL) and is a format used to store multimedia playlists. A M3U file is a text file that contains the locations of one or more media files for a media player to play.

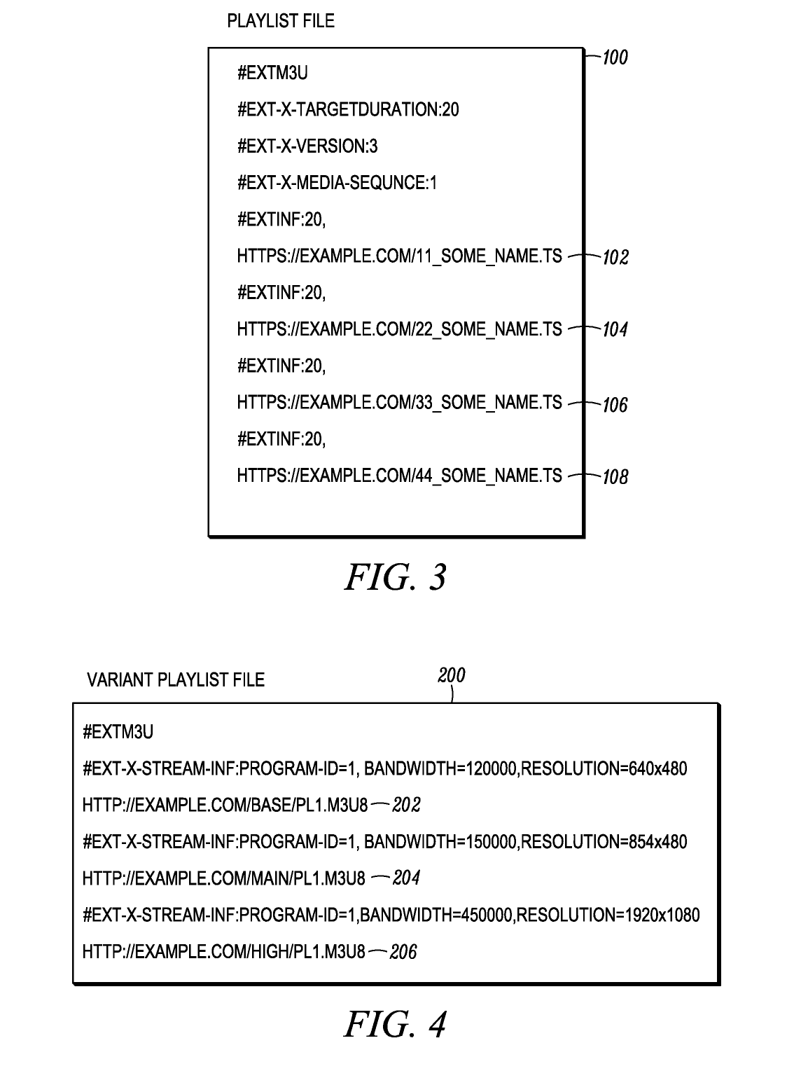

FIG. 3 provides an example of a playlist file 100 that can be given a filename PL1.m3u8. The playlist file 100 includes tags or addresses for media files. In the example provided in FIG. 3, tags 102, 104, 106 and 108 are provided for media files 11_some name.ts, 22_some name.ts, 33_some_name.ts, and 44_some name.ts, respectively. Play duration of media contained in each media file listed in playlist file 100 is 20 seconds.

The end or HLS client device 14 obtains the playlist file from the server 26 and obtains and plays each media data file indicated by the playlist file. Typically, during playback, the end or client device 14 must dynamically and repeatedly reload the playlist file to discover additional and/or different media segments.

In addition, different playlist files depending upon bitrate and video image resolution are stored on the server 26 and are available for being downloaded by the end or HLS client device 14. Table 1 indicates examples of different available profiles that may be available for a particular content.

TABLE 1

| Profile # | Stream | Container | Codec | Type | Resolution | FPS | Bit Rate |
|---|---|---|---|---|---|---|---|
| 1 | SPTS | MPEG2-TS | AVC | High 4.1 | 1920 × 1080 | 29.97 | 6.750 |
| 2 | SPTS | MPEG2-TS | AVC | High 4.1 | 1920 × 1080 | 29.97 | 4.500 |
| 3 | SPTS | MPEG2-TS | AVC | High 4.1 | 1920 × 1080 | 29.97 | 3.000 |
| 4 | SPTS | MPEG2-TS | AVC | High 4.1 | 1280 × 720 | 29.97 | 4.125 |
| 5 | SPTS | MPEG2-TS | AVC | High 4.1 | 1280 × 720 | 29.97 | 2.750 |
| 6 | SPTS | MPEG2-TS | AVC | Main 3.0 | 1280 × 720 | 29.97 | 2.500 |
| 7 | SPTS | MPEG2-TS | AVC | Main 3.0 | 854 × 480 | 29.97 | 1.500 |
| 8 | SPTS | MPEG2-TS | AVC | Main 3.0 | 854 × 480 | 29.97 | 1.000 |
| 9 | SPTS | MPEG2-TS | AVC | Main 3.0 | 640 × 360 | 29.97 | 0.600 |
| 10 | SPTS | MPEG2-TS | AVC | Main 3.0 | 416 × 240 | 29.97 | 0.250 |
| 11 | SPTS | MPEG2-TS | AVC | Main 3.0 | 640 × 480 | 29.97 | 1.250 |
| 12 | SPTS | MPEG2-TS | AVC | Main 3.0 | 640 × 480 | 29.97 | 0.900 |
| 13 | SPTS | MPEG2-TS | AVC | Main 3.0 | 480 × 360 | 29.97 | 0.500 |
| 14 | SPTS | MPEG2-TS | AVC | Main 3.0 | 320 × 240 | 29.97 | 0.250 |
| 15 | SPTS | MPEG2-TS | AVC | Base 3.0 | 848 × 480 | 29.97 | 0.700 |
| 16 | SPTS | MPEG2-TS | AVC | Base 3.0 | 640 × 480 | 29.97 | 1.200 |
| 17 | SPTS | MPEG2-TS | AVC | Base 3.0 | 640 × 480 | 29.97 | 0.900 |
| 18 | SPTS | MPEG2-TS | AVC | Base 3.0 | 480 × 320 | 29.97 | 0.900 |
| 19 | SPTS | MPEG2-TS | AVC | Base 3.0 | 480 × 320 | 29.97 | 0.600 |

In the example provided by Table 1, a total of 19 different playlists may be available for download from the server 26 for a particular or selected multimedia presentation. Each is provided as a single program transport stream in the form of MPEG2-TS and is AVC encoded. The type of each profile is one of High 4.1, Main 3.0, of Base 3.0, the video image resolutions are form 320×240 to 1920×1080, and the frames per second (FPS) are 29.97 for each. Most importantly, each is provided at a different bit rate, for instance, from 0.250 to 6.750. The HLS client device 14 determines which or how many profiles to download depending upon available bandwidth conditions and, in some cases, playback capability of the device or connected devices.

Typically, the streaming server 26 provides the end or client devices 14 with a variant playlist file that lists each variant profile. For example, the streaming server 26 may send the information provided in Table 1 to a client device 14 interested in streaming the content associated with Table 1. As a further example, FIG. 4 provides a variant playlist file 200 including three URL tags 202, 204 and 206 providing address information corresponding to three playlist files (i.e., corresponding to base, main and, high variant stream profiles).

The end or client device 14 may be required to frequently and periodically reload each of the profiles or playlist files. When a client device 14 reloads each playlist file, the client device 14 must analyze the reloaded playlist file and determine if any changes have been made to the playlist file since the last time the playlist file was downloaded. Accordingly, the client device must be able to download, maintain and compare numerous playlists for a given content.

According to an embodiment, the end or client device 14 downloads and maintains a plurality of playlist files for the same content in the following manner. As opposed to having the client device 14 periodically reload the playlist file and use its available resources for maintaining and comparing reloaded playlist files from previously loaded playlist files for a plurality of playlist files, a technique is provided in which any modification to a playlist file is first indicated to the client device 14 before any further reloading operation. Thus, reloading occurs only after the streaming server 26 has actually modified the playlist files. This eliminates the burden on the client device 14 to periodically perform HTTP fetching of playlist files and comparisons needed to determine if playlist files have been updated. Rather, according to this embodiment, the client device 14 is informed from an external source that playlist files have been updated or changed and is thereby notified to reload the updated version of the playlist files. The burden of comparing playlist files no longer resides with the client device 14.

According to a first embodiment, the streaming server 26 has an event update event notification module 38 and is the external source that is required to inform end or client devices 14 that a playlist has been modified. With respect to the system illustrated in FIG. 1, this can be accomplished by having the streaming server 26 cause a multicast or unicast to be transmitted over the network 10 from the headend 12 to the client or end devices 14 that a playlist has changed. For purposes of this disclosure, a multicast refers to a single stream of data (i.e., a set of packets) that is transmitted simultaneously to selected multiple client devices or hosts who that have joined the appropriate multicast group, and unicast refers to communication between a single sender (i.e., the HLS server) and a single receiver (i.e., a single HLS client device) over the network.

A client device 14 that receives such an update event notification for a multimedia presentation as the multimedia presentation is being played by the client device 14 or caused to be played by the client device 14 (i.e., being output for playing on another device) performs a HTTP fetch or like transfer operation of the updated playlist files. The client device 14 in this embodiment merely needs to replace the previous version of playlist files with the updated playlist files. A comparison of playlist files and a determination with respect to identifying changes is not required of the client device 14 and its resources.

As a second and alternative embodiment, the use of an intermediate server 40 can be utilized. See FIG. 1. According to this embodiment, the intermediate server 40 has an event update event notification module as discussed above and functions as a HLS client device and periodically checks if the playlist files available for a particular content, program, or multimedia presentation have been modified. If the intermediate server 40 determines that playlist files have been updated or modified, the intermediate server 40 indicates by a unicast or multicast transmission to the HLS client devices 14, such as set-top boxes on the network 10, to reload playlist files from the HLS streaming server 26. As above, the client device 14 is not required to periodically perform a HTTP fetch of playlist files and perform a comparison to determine if changes/updates exist. Rather, this is accomplished by the intermediate server 40 thereby freeing up resources of the client devices 14.

With respect to either of the above referenced embodiments, the unicast or multicast transmission of an event update notification can be provided as a User Datagram Protocol (UDP) message. UDP is a communications protocol that offers a limited amount of service when messages are exchanged between computers in a network that uses the Internet Protocol (IP). Typically, UDP is used when the desire is save processing time and bandwidth because only very small data units that do not require reassembly upon receipt are transferred typically with no acknowledgements. Accordingly, the client devices that have subscribed to the event update notification service of the above embodiments can listen for the UDP message via a UDP port and only seek to reload playlist files upon receipt of the above UDP message notification.

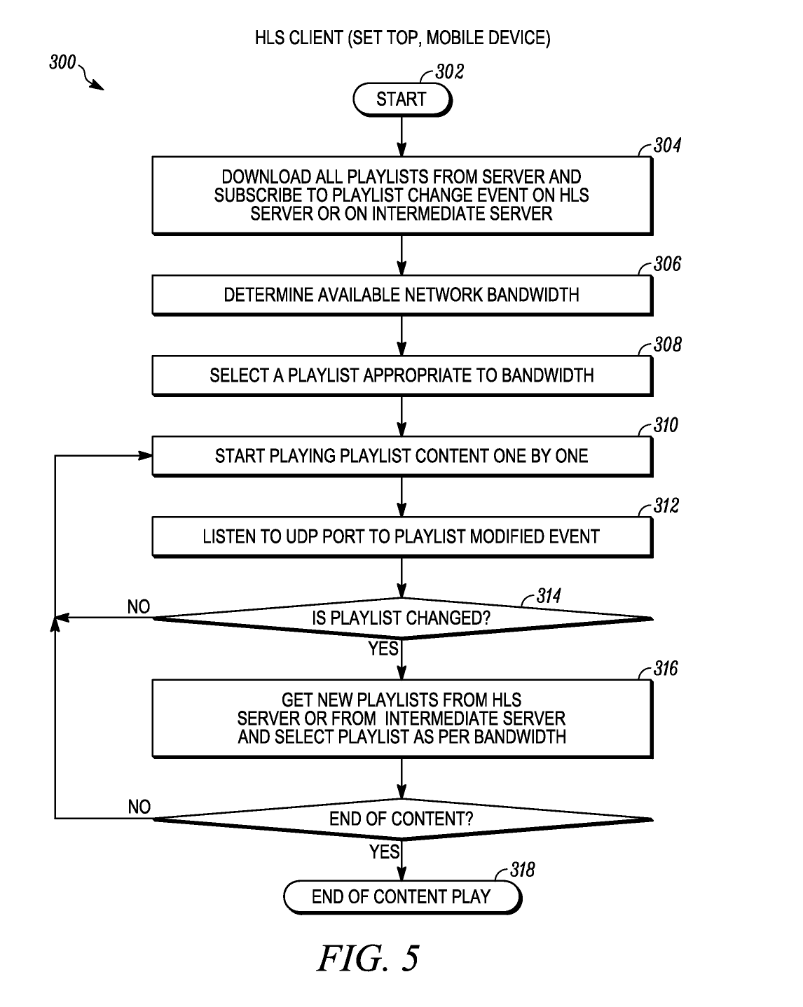

The above embodiments are illustrated in the flowchart 300 provided by FIG. 5. With respect to the first embodiment, a HLS client device 14, such as a set-top box, downloads all or at least some of the playlist files for a particular multimedia presentation from the streaming server 26 and subscribes to a playlist update event notification service with the streaming server 26. See steps 302 and 304. Thereafter, the client device 14 makes a determination of available network bandwidth in step 306 and then selects an appropriate playlist file depending upon bandwidth in step 308. The selection of the playlist file may also take video image resolution into account depending upon the capability of the client device and or associated devices on which the multimedia presentation may be displayed. The client device 14 then begins to play media files identified by the selected playlist file one by one as typically accomplished for HLS. See step 310. Here, the client device 14 may output video and audio signals for another device to display the content such as on a television monitor, may have integral components permitting the content to be played, or may transmit the signals to a wireless device or local area network.

While the content is playing as described above, which can include switching between different encodings or profiles dynamically to adapt to changing bandwidth availability or other issues, the following steps are performed in the background. The client device 14 listens to a designated UDP port for a playlist update event. See step 312. If no update event notification has been received in step 314, the client device continues playing of the content as in step 310. However, when playlist files are updated as indicated in step 314, the streaming server 26 sends a multicast or unicast to subscribed client devices 14 that an update has been made to the playlist files of the particular content. As a result, the client device 14 reloads playlist files with an HTTP fetch from the streaming server 26 in step 316 and selects a playlist file based on bandwidth availability and continues to play the content, one media file at a time in sequential order. This continues until the end of the content has been reached in step 318, and the client device 14 terminates the playback operation.

According to the second embodiment which requires the use of an intermediate server 40, the HLS client device 14 and the intermediate server 40 download playlist files for a particular content from the streaming server 26. Here, the intermediate server 40 acts as a traditional HLS client device while the HLS client device 14 follows the steps recited in FIG. 5. The client device 14 subscribes to a playlist change event notification service from the intermediate server 40 in step 304 and listens to a designated UDP port for playlist update event notifications in step 312. An advantage of using an intermediate server 40 is that off-the-self or currently deployed streaming servers need not be modified to incorporate the above described process.

As before, the client device 14 determines available network bandwidth in step 306, selects an appropriate playlist depending upon bandwidth in step 308 for purposes of obtaining and playing media files, and starts playing media files listed in playlist files one by one in sequential order in step 310. While the client device 14 plays the content or causes the content to be played on another device, the intermediate server 40 periodically reloads the playlist files for this particular content from the streaming server 26 and performs a comparison with previously obtained playlist files to determine if files have been changed. Provided that no files have been updated by the streaming server 26, the client device 14 merely continues to play the content without need of reloading the playlist files. However, in the event of an update of playlist files, the intermediate server 40 makes such a determination and indicates this to subscribed client devices 14 by a UDP multicast or unicast over network 10.

Upon receiving an update event notification form the intermediate server 40, the client device 14 reloads the updated playlist files from the streaming server 26 and selects an appropriate encoding or profile based on bandwidth availability and continues to play the content with the updated files.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as critical, required, or essential features or elements.

The above referenced devices, servers, components, equipment, boxes, tuners and the like for carrying out the above methods can physically be provided on a circuit board or within another electronic device and can include various processors, microprocessors, controllers, chips, disk drives, and the like. It will be apparent to one of ordinary skill in the art that the processors, controllers, tuners, units, and the like may be implemented as electronic components, software, hardware or a combination of hardware and software. One of ordinary skill in the art appreciates that various modifications and changes can be made without departing from the scope of these embodiments as defined in the appended claims.

We claim:

1. A method of streaming multimedia data over a network to a client device, comprising the steps of:
downloading at least one playlist file using a transfer protocol over the network from a streaming server for a selected multimedia presentation;
subscribing to an update event notification service with respect to the at least one playlist file for the selected multimedia presentation;
receiving an update event notification with respect to the at least one playlist file for the selected multimedia presentation; and
after said receiving step, downloading an updated version of the at least one playlist file using the transfer protocol over the network from the streaming server.

2. A method according to claim 1, wherein the transfer protocol is Hypertext Transfer Protocol (HTTP) Live Streaming (HLS), wherein said downloading, subscribing, and receiving steps are performed electronically with the client device, and wherein the downloading steps are performed as HTTP fetches by the client device.

3. A method according to claim 1, wherein the at least one playlist file provides an ordered list of Universal Resource Indicators (URIs) for a plurality of media files providing a contiguous time based stream of multimedia data for use in playing the multimedia presentation, and wherein the client device is selected from a group consisting of a set-top box, a server, a gateway, a computer, an IP client device, a wireless electronic device, a tablet, a laptop computer, and a smartphone.

4. A method according to claim 1, wherein, during said subscribing step, the client device subscribes to the streaming server for the update event notification service, and wherein, during said receiving step, the client device receives the update event notification from the streaming server.

5. A method according to claim 1, wherein, during said subscribing step, the client device subscribes to an intermediate server different from the streaming server for the update event notification service, and wherein, during said receiving step, the client device receives the update event notification from the intermediate server.

6. A method according to claim 1, further comprising the step of listening with the client device for the update event notification and refraining from performing said downloading step for the updated version until after the update event notification is received.

7. A method according to claim 6, wherein the update event notification is provided as a User Datagram Protocol (UDP) message, and wherein, during said listening step, the client device listens for the UDP message via a UDP port.

8. A method according to claim 6, further comprising the steps of:
downloading media files identified by the playlist file; and
causing the multimedia presentation to be played;
wherein said subscribing step is performed before the multimedia presentation is played; and
wherein said listening step is performed while the multimedia presentation is played and is terminated when the multimedia presentation is finished being played.

9. A method according to claim 1, wherein said downloading steps include loading a plurality of playlist files for the selected multimedia presentation with each of the plurality of playlist files providing a different encoding of the selected multimedia presentation, wherein each different encoding provides a unique combination of bit rate and video image resolution, and wherein the method further comprises the step of selecting one of the playlist files from the plurality of playlist files for use in playing the multimedia presentation based on a determination of available bandwidth and image resolution capability.

10. A method of streaming multimedia data from a streaming server over a network to a population of client devices, comprising the steps of:
providing at least one playlist file for a selected multimedia presentation for being downloaded by the population of client devices with a transfer protocol over the network;
receiving a subscription request from at least one of the population of client devices to an update event notification service with respect to updates made to the at least one playlist file for the selected multimedia presentation; and
transmitting an update event notification to the at least one of the population of client devices from which a subscription request was received when an updated version of the at least one playlist file is available for being downloaded by the population of client devices with the transfer protocol over the network.

11. A method according to claim 10, wherein the transfer protocol is Hypertext Transfer Protocol (HTTP) Live Streaming (HLS), and wherein said providing, receiving and transmitting steps are performed electronically with the streaming server.

12. A method according to claim 11, wherein the network is a hybrid fiber-coax cable (HFC) network and the streaming server communicates with the headend of the network.

13. A method according to claim 10, wherein said step of transmitting the update event notification is performed as a multicast transmission.

14. A method according to claim 10, wherein said step of transmitting the update event notification is performed as a unicast transmission.

15. A method according to claim 10, wherein the update event notification is in a form of a User Datagram Protocol (UDP) message.

16. A method according to claim 10, further comprising the steps of:
dividing a continuous stream providing the selected multimedia presentation into individual media files;
creating a Universal Resource Indicator (URI) for each of the individual media files;
generating the at least one playlist file providing an ordered list of URIs for the media files; and
updating the at least one playlist file;
wherein said transmitting step is performed after said updating step each time said updating step is performed.

17. A method according to claim 10, wherein said at least one playlist file includes a plurality of playlist files for the selected multimedia presentation with each of the plurality of playlist files providing a different encoding of the selected multimedia presentation, wherein each different encoding provides a unique combination of bit rate and video image resolution.

18. A method of streaming multimedia data over a network to a population of client devices, comprising the steps of:
downloading at least one playlist file from a streaming server for a selected multimedia presentation over the network using a transfer protocol;
periodically reloading the at least one playlist file from the streaming server for the selected multimedia presentation over the network using the transfer protocol;
determining if a version of the at least one playlist file obtained by said reloading step has been updated relative to a previously loaded version;
receiving a subscription request from at least one of the population of client devices to an update event notification service with respect to updates made to the at least one playlist file for the selected multimedia presentation; and
transmitting an update event notification to the at least one of the population of client devices from which a subscription request was received when an updated version of the at least one playlist file is available for being downloaded by the population of client devices from the streaming server.

19. A method according to claim 18, wherein the transfer protocol is Hypertext Transfer Protocol (HTTP) Live Streaming (HLS), and wherein said downloading, reloading, determining, receiving and transmitting steps are performed electronically with an intermediate server different from the streaming server.

20. A method according to claim 18, wherein said step of transmitting the update event notification is performed as at least one of a multicast transmission and unicast transmission and is in a form of a User Datagram Protocol (UDP) message.
